(19) United States
(12) Patent Application Publication
(10) Pub. No.: US 2014/0203027 A1
(43) Pub. Date: Jul. 24, 2014

(54) MULTILAYER PLASTIC TUBE

(71) Applicants: Miroslav Planeta, Mississauga (CA); Harinder Tamber, Brampton (CA)

(72) Inventors: Miroslav Planeta, Mississauga (CA); Harinder Tamber, Brampton (CA)

(73) Assignee: MACRO ENGINEERING & TECHNOLOGY INC., Mississauga, Ontario (CA)

(21) Appl. No.: 14/116,508

(22) PCT Filed: May 10, 2012
(86) PCT No.: PCT/CA2012/000447

§ 371 Date: Jan. 22, 2014

Related U.S. Application Data
(60) Provisional application No. 61/485,615, filed on May 12, 2011.

(51) Int. Cl. B32B 1/08; B32B 1/02

(52) U.S. Cl. CPC B32B 1/08; B32B 1/02
USPC 220/660; 138/140

(57) ABSTRACT

Packaging containing a PVDC barrier layer is manufactured without any significant orientation, with the result that the PVDC harrier layer remains flexible at significantly greater thicknesses than when it is oriented. This increased thickness compensates for the reduced barrier properties resulting from less crystallinity of the PVDC, and hence multilayer plastic tubing can be manufactured in which PVDC is used as a barrier layer instead of aluminum.

### TECHNICAL FIELD

The present disclosure relates to multilayer plastic tubing, and more particularly to multilayer plastic tubing having at least one barrier layer.

### BACKGROUND

It is common to use containers formed from a section of flexible tubing to contain viscous liquids such as toothpaste. Such tubing typically includes a thin aluminum foil barrier layer to retain moisture in the contained product and prevent the escape of flavors and fragrances.

The aluminum foil barrier layer makes it difficult to pass these tubes through metal detectors for quality control. In addition, although the aluminum foil has excellent barrier properties, due to the poor elongation of metal, any stretch or twist during a converting or filling operation can result in pin holes or flex cracks that undermine the integrity of the barrier layer. The aluminum foil barrier layer also makes it very difficult to effectively recycle such tubes.

Other flexible tubes may use an ethylene vinyl alcohol (EVOH) based harrier layer. However, the moisture barrier properties of EVOH are limited because EVOH is a hydrophilic material, and the oxygen barrier properties of EVOH are not ideal because they are dependent on the relative humidity (RH)—the higher the relative humidity at the EVOH barrier layer, the lower the effectiveness of EVOH as an oxygen barrier. In order to attain high oxygen barrier properties for EVOH, grades with low ethylene content, such as EVOH-29 or EVOH-27, are used, but the lower ethylene content or higher VOH content make the EVOH more susceptible to intake of moisture, more difficult to process and increases the chances of flex cracks.

On the other hand, PVDC has excellent oxygen and moisture barrier properties, and its oxygen barrier property is not RH dependent, which means that even at high relative humidity it has high oxygen barrier properties. PVDC is used in medical packaging (latex coating) and in meat and cheese packaging as shrink bags due to its excellent barrier properties. For example, U.S. Pat. No. 6,159,616 to Planeta et al. teaches a multilayer plastic film having at least two inner PVDC layers, outer layers comprising a polyolefin homopolymer, copolymer or ionomer, and bonding layers between the PVDC layers and between the PVDC layers and the outer layers.

However, as explained in the background section of U.S. Pat. No. 6,159,616, cracking in a layer is a general problem in the manufacturing of multilayer film, especially when utilizing rigid or easily degradable polymers such as PVDC, and U.S. Pat. No. 6,159,616 teaches that the thickness of such a barrier layer therefore has to be limited to minimize the likelihood of cracking. To overcome this difficulty, U.S. Pat. No. 6,159,616 teaches a multilayer plastic film having at least two inner polyvinylidene chloride (PVDC) layers, outer layers comprising a polyolefin homopolymer, copolymer or ionomer, and bonding layers between the PVDC layers and between the PVDC layers and the outer layers, and teaches that each PVDC layer should have a thickness in the range of from about 3 to about 15 microns, preferably in the range of from about 3 to about 10 microns. In particular, multilayer films are typically biaxially oriented (stretched) in order to provide shrink properties. This orientation increases the crystallinity of the PVDC which increases its barrier properties, but also makes it more rigid and brittle and hence susceptible to flex cracks unless its thickness is limited.

### SUMMARY

Packaging containing a PVDC barrier layer is semicrystalline, that is, unstretched and manufactured without any significant orientation, with the result that the PVDC barrier layer remains flexible at significantly greater thicknesses than when it is oriented. This increased thickness compensates for the reduced barrier properties resulting from less crystallinity of the PVDC, and hence multilayer plastic tubing can be manufactured in which PVDC is used as a barrier layer instead of aluminum. Such tubing is useful in packaging for containing liquids and powders.

In one aspect, a multilayer plastic tube has a lumen surface layer and an outer surface layer each comprising a polymer, at least one polyvinylidene chloride (PVDC) barrier layer disposed between the lumen surface layer and the outer surface layer, and bonding layers between each adjacent pair of layers. The tube has a total wall thickness in the range of from about 250 microns to about 1.5 millimeters and the tube is unstretched.

In an embodiment, each PVDC, barrier layer comprises from about 90% to about 98% by weight of vinylidene chloride, preferably from about 95% to about 98% by weight of vinylidene chloride.

In an embodiment, each PVDC barrier layer comprises at least one copolymer selected from the group consisting of vinylidene chloride-methyl acrylate copolymer, vinylidene chloride-vinyl chloride copolymer and vinylidene chloride-acrylic acid copolymer.

In an embodiment, the cumulative total thickness of the at least one PVDC barrier layer is in the range of from about 125 to about 1250 microns, preferably from about 250 to about 1000 microns.

In an embodiment, the surface layers make up between about 20% to about 80% of the total wall thickness, preferably about 30% to about 70% of the total wall thickness. In a particular embodiment, each surface layer makes up between about 15% to about 35% of the total wall thickness. The surface layers may each have a different thickness or may each have substantially equal thickness.

In an embodiment, the outer surface layer comprises a polymer selected from the group consisting of polyolefin homopolymer, copolymer or ionomer, nylon, polyester, cyclic olefin copolymer, and acid copolymer. Preferably, the outer surface layer comprises at least one material selected from the group consisting of low density polyethylene, linear low density polyethylene, metalocens-based linear low density polyethylene, polypropylene, copolymers of polypropylene, high density polyethylene and ionomers.

In an embodiment, the lumen surface layer comprises a polymer selected from the group consisting of polyolefin homopolymer, copolymer or ionomer, cyclic olefin copolymer, and acid copolymer. Preferably, the lumen surface layer comprises at least one material selected from the group consisting of low density polyethylene, linear low density polyethylene, metalocens-based linear low density polyethylene, polypropylene, copolymers of polypropylene, high density polyethylene and ionomers.

In an embodiment, each bonding layer has a thickness in the range of from about 3 microns to about 25 microns. Each bonding layer may comprise at least one material selected from the group consisting of ethylene vinyl acetate, ethylene methyl-acrylate and ethylene-acrylic acid copolymer.

In an embodiment, the tube has a diameter less than 100 mm, preferably less than 50 mm.

In one embodiment, the multilayer plastic tube has one PVDC layer, in another embodiment the multilayer plastic tube has two PVDC barrier layers, and in another embodiment the multilayer plastic tube has three PVDC harrier layers.

A container may be formed from a section of multilayer plastic tube as described herein, with the tube section having a closed end and an open end and the open end having a closure fixture for receiving a closure. A quantity of liquid, for example a viscous liquid, or a quantity of powder may be disposed in the tube section and sealed therein by a closure.

### BRIEF DESCRIPTION OF THE DRAWINGS

These and other features will become more apparent from the following description in which reference is made to the appended drawings wherein:

FIG. 1 is a schematic cross-sectional view of a first exemplary multilayer plastic tube;

FIG. 2 is a schematic cross-sectional view of a second exemplary multilayer plastic tube;

FIG. 3 is a schematic cross-sectional view of a third exemplary multilayer plastic tube;

FIG. 4 is a schematic diagram showing the production of multilayer plastic tube; and

FIG. 5 is a perspective view showing an exemplary tubular container formed from multilayer plastic tube.

### DETAILED DESCRIPTION

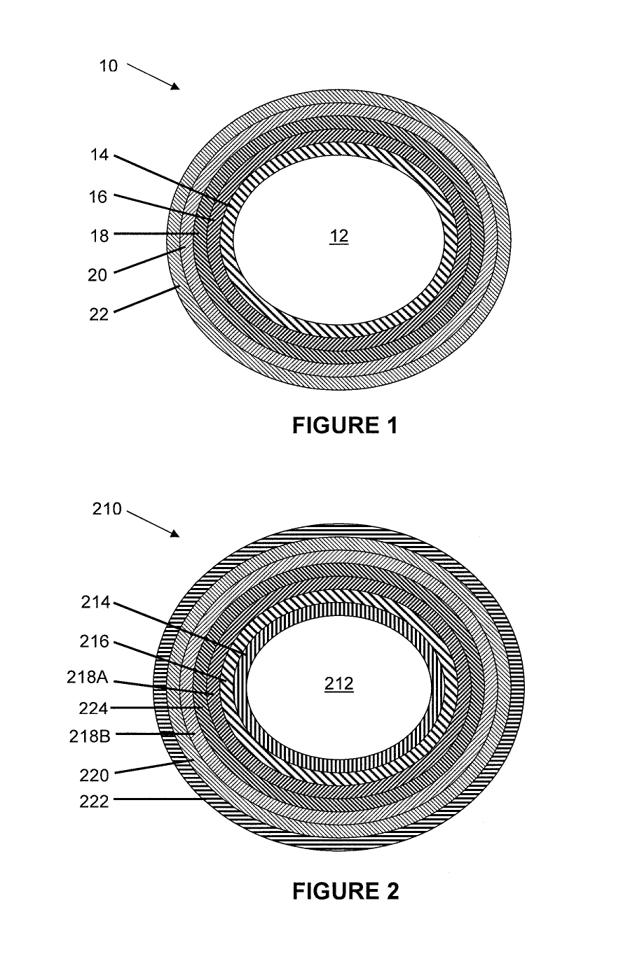

Referring now to FIG. 1, a first exemplary multilayer plastic tube is shown in cross section and is indicated generally by the reference numeral 10. The multilayer plastic tube 10 is a five layer tube which has a central lumen 12 and comprises a lumen surface layer 14, a first bonding layer 16, an interior barrier layer 18, a second bonding layer 20 and an outer surface layer 22. The first bonding layer 16 adheres the lumen surface layer 14 to the interior barrier layer 18 and is disposed therebetween, and the second bonding layer 20 adheres the interior barrier layer 18 to the outer surface layer 22 and is disposed therebetween, so that the interior barrier layer 18 is disposed between and adhered to the lumen surface layer 14 and the outer surface layer 22. Each of the lumen surface layer 14 and the outer surface layer 22 comprises a suitable polymer, and the barrier layer 18 comprises polyvinylidene chloride (PVDC).

The lumen surface layer 14 may comprise a polyolefin homopolymer, copolymer or ionomer, a cyclic olefin copolymer or an acid copolymer. In a preferred embodiment, the lumen surface layer 14 comprises low density polyethylene, linear low density polyethylene, metalocens-based linear low density polyethylene, polypropylene, copolymers of polypropylene, high density polyethylene and ionomers or suitable combinations of the foregoing. Olefin copolymers or ionomers containing 90 to 98% by weight of ethylene or olefin homopolymers may be used. The lumen surface layer 14 provides heat sealing ability, oil resistance in the presence of fats and seal strength.

In a preferred embodiment, the PVDC barrier layer comprises 90 to 98% by weight of vinylidene chloride, more preferably from about 95 to about 98% by weight of vinylidene chloride, with methyl acrylate, vinyl chloride or acrylic acid, together with heat stabilizers and plasticizers known in the art. The PVDC barrier layer provides oxygen and moisture barrier properties and also possesses oil resisting properties.

The outer surface layer 22 may comprise a polyolefin homopolymer, copolymer or ionomer, nylon, polyester, a cyclic olefin copolymer or an acid copolymer. In a preferred embodiment, the outer surface layer 22 comprises low density polyethylene, linear low density polyethylene, metalocens-based linear low density polyethylene, polypropylene, copolymers of polypropylene, high density polyethylene and ionomers or a suitable combination of one or more of the foregoing. Olefin copolymers or monomers containing from about 90 to about 98% by weight of ethylene or olefin homopolymers as a PP and CPP may be used. The outer surface layer 22 provides abuse resistance during handling and transportation, as well as temperature resistance.

The bonding layers 16, 20 between each adjacent pair of layers 14, 18, 18, 22 may comprise ethylene-vinyl acetate, ethylene methyl-acrylate and ethylene-acrylic acid copolymer or suitable combinations of the foregoing. For example, the bonding layers may comprise ethylene vinyl acetate copolymer having a melt index from about 0.1 to about 6.0 decigram per minute, and a vinyl acetate content of from 9 to 36% by weight based on the weight of the copolymer. A blend of two or more ethylene-vinyl acetate copolymers may be used in the bonding layers 16, 20. Where ethylene acrylates are used in the bonding layers 16, 20, the acrylate contents are preferably from about 2 to about 24% by weight of the polymer with a melt index of from about 0.1 to about 6 decigram per minute.

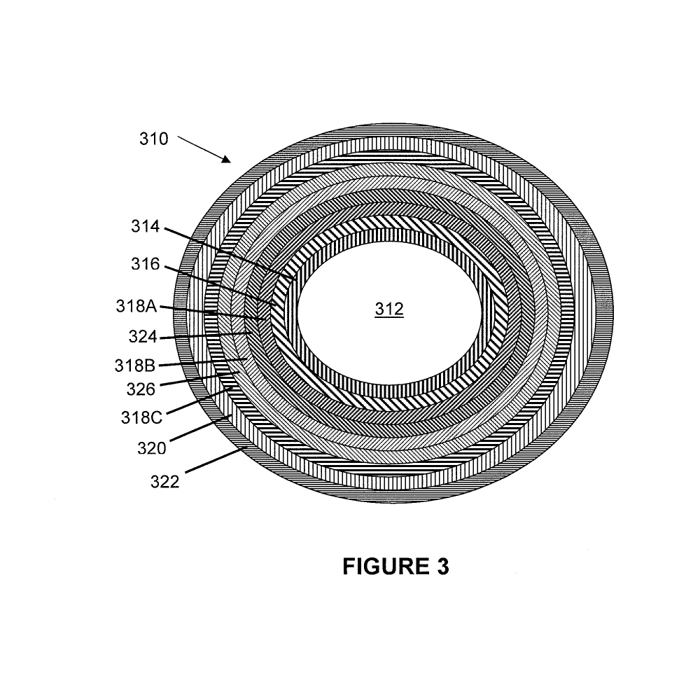

The first exemplary multilayer plastic tube 10 has only a single PVDC barrier layer. In other embodiments, multilayer plastic tube may comprise a plurality of PVDC barrier layers separated by bonding layers. For example, FIG. 2 shows a multilayer plastic tube 210 which has two inner PVDC barrier layers 218A, 218B adhered to one another, and separated by, a bonding layer 224, and FIG. 3 shows a multilayer plastic tube 310 which has three inner PVDC barrier layers 318A, 318B, 318C with each PVDC barrier layer 318A, 318B, 318C adhered to and separated from each adjacent PV DC barrier layer 318A, 318B, 318C by respective bonding layers 324, 326. In FIGS. 2 and 3, corresponding features are denoted by corresponding reference numerals, except beginning with the prefix “2” (for FIG. 2) or “3” (for FIG. 3) and with the suffixes “A”, “B” and “C” used to distinguish the different inner PVDC barrier layers, and identical materials may be used for the various components. FIGS. 1, 2 and 3 are schematic representations presented for ease of illustration, and the lumen 10, 210, 310 and layers are not shown to scale.

Tubes as described herein, such as the exemplary tdbes 10, 210, 310 shown in FIGS. 1, 2 and 3, respectively, will preferably have a total wall thickness, including the lumen surface layers 14, 214, 314, inner PVDC barrier layers 18, 218A, 218B, 318A, 318B, 318C, outer surface layers 22, 222, 322 and bonding layers 16, 20, 216, 220, 224, 316, 320, 324, 326, in the range of from about 250 microns to about 1.5 millimeters. Tubes as described herein, such as the exemplary tubes 10, 210, 310 shown in FIGS. 1, 2 and 3, respectively, will preferably have a diameter less than 100 mm, and more preferably less than 50 mm. Such tubes are preferably flexible and resilient.

The surface layers 14, 22, 214, 222, 314, 322 make up between about 20% to about 80% of the total wall thickness, and preferably between about 30% to about 70% of the total wan thickness, with each surface layer 14, 22, 214, 222, 314, 322 making up between about 15% to about 35% of the total wall thickness. The surface layers 14, 22, 214, 222, 314, 322 may have a different thicknesses or may have substantially identical thickness. The cumulative total thickness of the inner PVDC barrier layer or layers is in the range of from about 125 to about 1250 microns, and preferably in the range of from about 250 to about 1000 microns. Thus, where there is only a single PVDC barrier layer 18, as shown in FIG. 1, the total thickness of that PVDC barrier layer 18 would be between about 125 and about 1250 microns, and preferably between about 250 and about 1000 microns. Where there are two PVDC, barrier layers 218A, 218B as shown in FIG. 3 or three PVDC barrier layers 318A, 318B, 318C as shown in FIG. 3, the total thicknesses of the PVDC barrier layers 218A, 218B or 318A, 318B, 318C, when added together, would be between about 125 and about 1250 microns, and preferably between about 250 and about 1000 microns. Each bonding layer 16, 20, 216, 220, 224, 316, 320, 324, 326 preferably has a thickness in the range of from about 3 microns to about 25 microns.

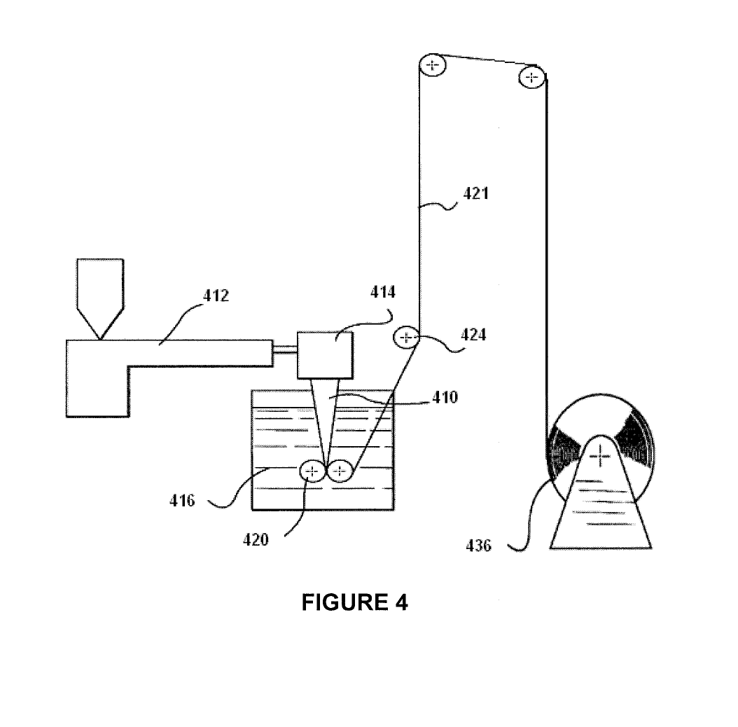

Tubes as described herein may be produced by known methods. Referring now to FIG. 4, a tube 421 is produced by using a plurality of extruders 412 (only one of which is shown for simplicity of illustration). The number of extruders 412 will depend on the number of layers in the tube 421, with one extruder for each layer. For example, where the tube 421 is a five layer tube such as the first exemplary tube 10, five extruders 412 will be used, where the tube 421 is a seven layer tube such as the second exemplary tube 210, seven extruders 412 will be used and where the tube 421 is a nine layer tube such as the third exemplary tube 310, nine extruders 412 will be used. The polymers extruded by the extruders 412 are fed to an annular die 414, and the tube 421 is extruded downwardly therefrom. The tube 421 is cooled in a cold water tank 416 located under the die 414 and containing water at a temperature of about 25° Celsius or lower. The bubble 410 formed by the tube 421 is squeezed out by nip rolls 420 in the cold water tank 416 which collapse the tube 421; the distance of the nip rolls 420 from the die 414 should be selected so that the tube 421 will have completely cooled and solidified before it reaches the nip rolls 420 so that the lumen surface layers do not bond to one another when the tube 420 passes through the nip rolls 420. The collapsed tube 421 from the cold water tank 416 is passed over idler rolls 424 to be wound in the form of a roll 436.

The die 414 or may be of the kind described in U.S. Pat. No. 5,788,902 (Planeta) issued Aug. 4, 1998 or in U.S. Pat. No. 6,116,885 (Planeta et al,) issued Sep. 12, 2000, the teachings of each of which are hereby incorporated by reference. These patents include disclosure relating to the extrusion of plastic materials in multilayer tubular film that is especially useful when one of the plastic materials (such as PVDC) is readily degradable.

When packaging containing a PVDC barrier layer is semicrystalline, that is, unstretched and manufactured without any significant orientation, the PVDC barrier layer remains flexible at significantly greater thicknesses than when it is oriented. This increased thickness compensates for the reduced barrier properties resulting from less crystallinity of the PVDC, and hence multilayer plastic tubing can be manufactured in which PVDC is used as a barrier layer instead of aluminum. Therefore, tubes as described herein, such as the exemplary tubes 10, 210, 310 described herein, are unstretched. As used herein, the term “unstretched” refers to tubing which is semicrystalline and has not undergone any significant orientation, or stretching, beyond that which is inherent in the extrusion, quenching and winding process.

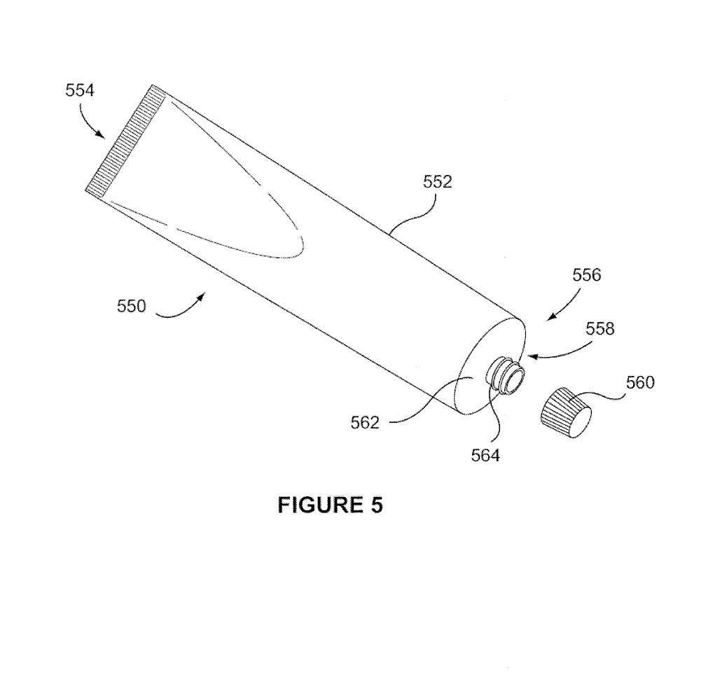

Multilayer plastic tubes as described herein, such as the exemplary tubes 10, 210, 310 shown in FIGS. 1, 2 and 3, respectively, may be used to form tubular containers. An exemplary such container is shown in FIG. 5 and indicated generally by the reference numeral 550. The container 550 comprises a section of multilayer plastic tube 552, such as one of the exemplary tubes 10, 210, 310 shown in FIGS. 1, 2 and 3, respectively, having a closed end 554 and an open end 556, with the open end 556 having a closure fixture 558 for securely receiving a closure 560. In the illustrated embodiment shown in FIG. 5, the closure fixture 558 comprises an end piece 562 which carries a hollow exteriorly threaded neck 564 opening into an interior volume of the container 550 and the closure 560 comprises a correspondingly interiorly threaded cap in other embodiments other types of closure fixtures and closures may be used. For example, a closure may incorporate a pump mechanism.

The container 550 may be formed by cutting the extruded multilayer plastic tube, such as one of the exemplary tubes 10, 210, 310 shown in FIGS. 1, 2 and 3, respectively, into sections of the desired length, crimping and heat sealing one end thereof to form the closed end 554 of the container and sealingly securing the end piece 562 and neck 564 to the opposite end, for example by welding or by suitable adhesive.

Containers as described herein can, in conjunction with their associated closures, be used to contain and dispense a wide variety of liquids and powders. For example, gels or viscous liquids such as toothpaste, tomato sauce, pizza sauce, processed cheese sauce, condiments such as ketchup, mustard, relish, or mayonnaise, cosmetic creams and pastes and even suitable adhesives may be stored in such containers.

Several currently preferred embodiments have been described by way of example. It will be apparent to persons skilled in the art that a number of variations and modifications can be made without departing from the scope of the claims.

The above description is intended in an illustrative rather than a restrictive sense. Variations to the exact embodiments described may be apparent to those skilled in the relevant art without departing from the spirit and scope of the claims set out below. It is intended that any such variations be deemed within the scope of this patent.

1. A multilayer plastic tube having:
a lumen surface layer and an outer surface layer each comprising a polymer;
at least one polyvinylidene chloride (PVDC) barrier layer disposed between the lumen surface layer and the outer surface layer; and
bonding layers between each adjacent pair of layers;
wherein:
the tube has a total wall thickness in the range of from about 250 microns to about 1.5 millimeters; and
the tube is unstretched.

2. A multilayer plastic tube according to claim 1 wherein each PVDC barrier layer comprises from about 90% to about 98% by weight of vinylidene chloride.

3. A multilayer plastic tube according to claim 2 wherein each PVDC barrier layer comprises from about 95% to about 98% by weight of vinylidene chloride.

4. A multilayer plastic tube according to claim 1 wherein each PVDC barrier layer comprises at least one copolymer selected from the group consisting of vinylidene chloride-methyl acrylate copolymer, vinylidene chloride-vinyl chloride copolymer and vinylidene chloride-acrylic acid copolymer.

5. A multilayer plastic tube according to claim 1 wherein cumulative total thickness of the at least one PVDC barrier layer is in the range of from about 12.5 to about 125.0 microns.

6. A multilayer plastic tube according to claim 5 wherein the cumulative total thickness of the at least one PVDC barrier layer is in the range of from about 25.0 to about 100.0 microns.

7. A multilayer plastic tube according to claim 1 wherein the surface layers make up between about 20% to about 80% of the total wall thickness.

8. A multilayer plastic tube according to claim 7 wherein the surface layers make up between about 30% to about 70% of the total wall thickness.

9. A multilayer plastic tube according to claim 8 wherein each surface layer makes up between about 15% to about 35% of the total wall thickness.

10. A multilayer plastic tube according to claim 9 wherein the surface layers each have a different thickness.

11. A multilayer plastic tube according to claim 9 wherein the surface layers each have substantially equal thickness.

12. A multilayer plastic tube according to claim 1 wherein the outer surface layer comprises a polymer selected from the group consisting of:
polyolefin homopolymer, copolymer or ionomer;
nylon;
polyester;
cyclic olefin copolymer; and
acid copolymer.

13. A multilayer plastic tube according to claim 12 wherein the outer surface layer comprises at least one material selected from the group consisting of low density polyethylene, linear low density polyethylene, metalocens-based linear low density polyethylene, polypropylene, copolymers of polypropylene, high density polyethylene and ionomers.

14. A multilayer plastic tube according to claim 1 wherein the lumen surface layer comprises a polymer selected from the group consisting of:
polyolefin homopolymer, copolymer or ionomer;
cyclic olefin copolymer; and
acid copolymer.

15. A multilayer plastic tube according to claim 14 wherein the lumen surface layer comprises at least one material selected from the group consisting of low density polyethylene, linear low density polyethylene, metalocens-based linear low density polyethylene, polypropylene, copolymers of polypropylene, high density polyethylene and ionomers.

16. A multilayer plastic tube according to claim 1 wherein each bonding layer has a thickness in the range of from about 3 microns to about 25 microns.

17. A multilayer plastic tube according to claim 1 wherein each bonding layer comprises at least one material selected from the group consisting of ethylene vinyl acetate, ethylene methyl-acrylate and ethylene-acrylic acid copolymer.

18. A multilayer plastic tube according to claim 1 wherein the tube has a diameter less than 100 mm.

19. A multilayer plastic tube according to claim 18 wherein the diameter of the tube is less than 50 mm.

20. A multilayer plastic tube according to claim 1, wherein the at least one PVDC barrier layer comprises two PVDC barrier layers.

21. A multilayer plastic tube according to claim 1, wherein the at least one PVDC barrier layer comprises three PVDC barrier layers.

22. A container formed from a tube section of the multilayer plastic tube according to claim 1, wherein:
the tube section has a closed end and an open end; and
the open end has a closure fixture for receiving a closure.

23. The container of claim 22, wherein a quantity of liquid is disposed in an interior volume of the tube section and sealed therein by a closure.

24. The container of claim 23, wherein the liquid is a viscous liquid.

25. The container of claim 22, wherein a quantity of powder is disposed in an interior volume of the tube section and sealed therein by a closure.
